(19) United States
(12) Patent Application Publication
(10) Pub. No.: US 2007/0198384 A1
(43) Pub. Date: Aug. 23, 2007

(54) Online systems for matching consumers and real estate professionals

(76) Inventor: David James Prouty, Lakeville, MN (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 11/703,499

(22) Filed: Feb. 7, 2007

Related U.S. Application Data
(60) Provisional application No. 60/765,959, filed on Feb. 7, 2006.

(51) Int. Cl. G06Q 40/00

(52) U.S. Cl. 705/35

(57) ABSTRACT

One embodiment of online systems for matching consumers and real estate professionals relates to collecting consumer information from a consumer and service provider information from a plurality of service providers through an internet-based interface and mediating an exchange of at least a portion of the information between the consumers and service providers. Some embodiments relate to controlling the anonymity of the consumer to minimize the pulling of credit scores, to matching consumers to local service providers, and providing interfaces to facilitate tight turnarounds between the time a quote is requested and the time a bid or quote is received.

### CROSS REFERENCE TO RELATED APPLICATIONS

This application claims priority to U.S. Provisional Patent Ser. No. 60/765,959 filed Feb. 7, 2006, and U.S. patent Ser. No., ______ entitled “INTERACTIVE WEBSITES” filed Feb. 6, 2007, which are hereby incorporated herein by reference.

### TECHNICAL FIELD OF THE INVENTION

The technical field of the invention relates to software for matching consumers and real estate professionals to exchange information whereby the consumers may retain professionals to receive real estate services.

### BACKGROUND

Consumers of real estate services (consumers) are presented with a tremendous variety of potential service providers. Real estate services include, for example, loans for residential, business, or investment properties and representation (or in consultation with a facilitator or trusted advisor) of the consumer as a buyer and/or a seller. Service providers include for example, lenders, loan officers, and agents such as realtors and real estate agents or brokers or insurance agents. In the face of such variety, the consumer often has difficulty determining which service providers are the best performers, most reputable, and the best value. Service providers are challenged by intense competition from other service providers and the need to identify consumers for their services.

### SUMMARY

Accordingly, a system that eliminates underperforming or disreputable service providers and identifies reputable and/or high performing service providers is needed. At the same time, service providers benefit from finding new consumers. Such a system is described herein.

The system includes a remotely accessible information site, e.g., a webpage, that is created by a program provider and is accessible by consumers. Consumers give information to the program provider about the services they desire, e.g., by entering information into the program provider's webpage. The program provider acts as an interface between consumers and service providers. Service providers use the interface to bid on the desired services. The program provider helps in the consumer's selection process and also helps service providers find consumers.

Consumers vary greatly in the kind of services they want and expect when buying and selling. The system disclosed herein allows consumers to find the type of services they desire at the price they are willing to pay. In some embodiments, the consumers are matched with local lenders. Local lenders are more familiar with the local market place and have more accountability since the consumer can come pay them a visit and word of mouth advertising (or negative remarks) can affect their business opportunities. Further, certain mortgage products are not allowed on certain types of housing, etc. Being local is a significant advantage in many situations. For instance, out of state lenders may not be responsive to whether or not the closing takes place in response to urgent need or critical timing considerations. With the consumer being far away, there can be less urgency in making sure the closing happens, and happens on time. When a closing does not take place, it can literally affect a dozen closings with the chain. Moreover, local service providers can be attuned to particular challenges in a market or as provided by local regulations.

Many different loans are often available for a particular transaction so that having access to a variety of loan offers can be advantageous. For instance, a loan for an empty lot for future home-building would often be treated in a variety of ways by different lenders. A relatively common treatment would involve an 80% loan to value loan. In relatively fewer cases, a 90% loan to value loan might be available. Only a few lenders however, would be likely to offer a 100% loan to value (zero down) on an empty buildable lot. Thus access to a variety of lenders is helpful to the consumer. For instance, consumers looking for non-routine purchases, e.g., cabin financing or hunting land financing often benefit from exploring options with as many lenders as is practically possible.

In some embodiments of the system, a guaranteed loan pricing is made available to the consumer. As predatory lending and bait and switch tactics increase every year, the feedback and guaranteed pricing will help prevent these unethical behaviors. Further, a guaranteed cost for the transaction is in contrast to a process that merely manually posts interest rates and/or has lenders contact the consumer, and when you search for a real estate agent. For instance, in some embodiments, the provider of the system requires the lender to use a particular formula for a given bid or transaction.

In some embodiments, the system helps to identify agents that specialize in the consumer's particular need—as opposed to merely providing a choice of brokerages based on limited criteria such as lowest overall transactional cost. Thus the system can advantageously provide a one-stop-shop for consumers to find the best lender, best product, best agent either locally or, if they choose, out of state to help them with their specific wants and needs, not a “one size fits all”. In some embodiments, the consumer picks the agent—as opposed to being contacted by a group of agents selected by a third party provider.

In some embodiments, consumers have the opportunity to use the system to access information about the agents. In some embodiments, the consumers have no access to the identity of the agents until the consumer chooses a subgroup of the agents that bid on the package of services requested by the consumer. The information about the agents may be provided, for instance, by a webpage that has information provided by the agent and/or provider and/or other consumers and/or third party agencies. In some aspects, this process levels the playing field for each agent and lender. For example, each agent has one page to tell the consumer why they should pick them. In some embodiments, this process is in contrast to alternative methods of providing consumers with agent searches, wherein consumers are directed to agents that are exclusive for that zip code—which is not a consumer friendly option since the consumer “gets” whoever was willing to pay enough to be the “exclusive agent” in that zip code.

Further, the provider may include both commercial and/or investment financing and/or residential financing. A one-stop-shop to cover all of the consumer's mortgage needs, including local commercial and investment property lenders and agents, is advantageously provided.

In some embodiments, a method for providing real estate services to a consumer is described, the method having various parts which may be optionally performed in the numerical order indicated comprising (1) collecting consumer information from a consumer and service provider information from a plurality of service providers through an internet-based interface and mediating an exchange of at least a portion of the information between the consumers and service providers, with the information being collected by a program provider and electronically stored by the program provider (i) with the consumer information being provided by the consumer in response to questions posed by the program provider and comprising a consumer information subset of data that comprises: (a) at least one service to be provided to the consumer that is a member of the group consisting of buying real estate property, selling real estate property, borrowing from a lender to buy real estate property, borrowing from a lender to build on real estate property, borrowing from a lender to refinance real estate property, borrowing from a lender to based on equity in real estate property, and obtaining home owner's insurance (b) a location of the real estate property for the service to be provided to the consumer, and (c) a credit history self-evaluation; with the service provider information being provided by the service provider in response to questions posed by the program provider comprising: (d) at least one service to be provided by the service provider that is a member of the group consisting of buying real estate property, selling real estate property, lending to buy real estate property, lending to build on real estate property, lending to refinance real estate property, lending based on equity in real estate property, and providing home owner's insurance (e) a location of the service provider, and (f) a true identity of the service provider; (2) identifying a predetermined number of service providers having a location within a predetermined distance of the location of the real estate property to generate a list of service providers; (3) sending the consumer information subset of data from the program provider to service providers on the list of service providers, with the consumer optionally being anonymous relative to the service providers (with the choice being the consumer's in some cases, or with the choice being made by the program provider in advance so that the consumer has no choice); (4) sending a quote from each of a plurality of the service providers on the list for the at least one service to be provided to the consumer to the program provider; conveying the quotes through the program provider to the consumer, with the quotes optionally being provided to the consumer within a predetermined time relative to the time of consumer's initiation of the quoting process; and (5) providing the quotes to the consumer with optional simultaneous access to a program/service provider summary page and contact information for the quoting service providers; (6) wherein the consumer is optionally anonymous relative to the service provider until the consumer chooses to contact the service provider.

### BRIEF DESCRIPTION OF THE FIGURES

FIG. 1 depicts a program provider system for collecting information from users such as consumers and service providers;

FIG. 2 depicts a program provider system for matching consumers and program providers and facilitating transactions;

FIG. 3 depicts an algorithm using location to match users to an area; and

FIG. 4 depicts an embodiment of a consumer's perspective of interacting with the program provider's system.

### DETAILED DESCRIPTION OF THE PREFERRED EMBODIMENTS

A number of persistent problems plague conventional approaches to matching consumers and real estate service providers through internet based competitive matching sites. One is that consumers prefer to be anonymous until they are ready to engage a service provider. Another is that pulling a credit score tends to depress the consumer's credit score, but consumers are sometimes forced to let their scores be pulled before they know if they will receive a desirable quote for the service they desire. Another problem is that consumers generally want quick quotes to be returned to them, but the quoting process is often lengthy. Another problem is that service providers can sometimes offer teaser or bait-and-switch quotes that are later changed or increased by additional fees that are introduced on some pretext. Another problem is that consumers are often unable to get suitable referrals to service providers when the service is in a new location, as when a consumer moves his residence or seeks a second home at a remote location.

The systems described herein address each of these problems, alone or in combination. In some aspects, the consumer's identity is kept anonymous for as long as possible, firstly with respect to the program provider and secondly with respect to the service provider. Controlled anonymity also addresses the problem of controlling the frequency of having a consumer's credit score pulled. One embodiment has the consumer self-evaluate their credit score as guided by questions from the program provider; thus a basis for generating bids is created while pulling credit scores is delayed until a mutually acceptable deal is reached. The speed of providing information can be addressed by identifying what services a consumer wants and then asking all of the pertinent questions at once instead of asking the consumer to complete multiple forms with redundancies. The problem of bait-and-switch or other aggressive tactics can be addressed by providing consumers with reviews of past performance of the service providers, with the reviews coming from consumers and/or the program provider, who has the option of requiring follow-up data to compare to the initially provided bids. Further, the desire for local service is addressed by configuring the program provider's system to account for the relative locations of the consumer, services to be provided, and the service providers.

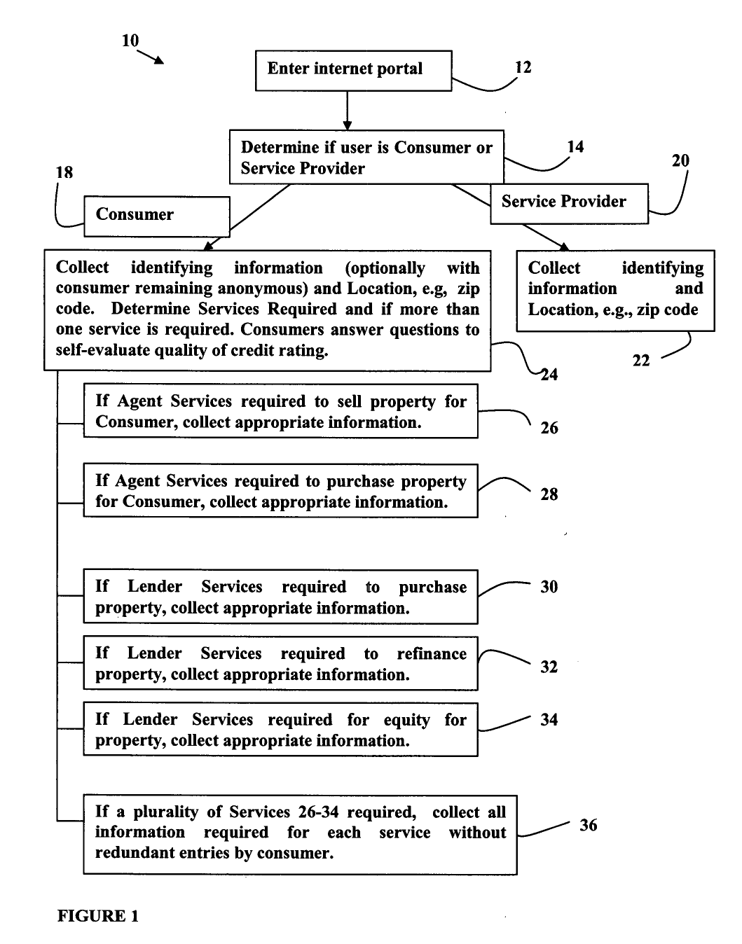

Referring to FIG. 1, software 10 for collecting information via an internet portal is depicted. A user enters the internet portal 12, and at 14 identifies himself as a consumer or service provider. A consumer is directed as in 18 and 24 to provide information about the desired services, location as related to the services, and is assigned an identity code by the software. In some embodiments, the consumer is anonymous relative to the software provider, meaning that the consumer does not provide his identity to the software provider. Alternatively, the consumer may be asked to provide identification at this juncture. The software then directs the consumer to provide additional information according to the desired service, as shown in FIG. 1, at 26 for Agent Services required to sell property for Consumer, at 28 for Agent Services required to purchase property for Consumer, at 30 for Lender Services required to purchase property, at 32 for Lender Services required to refinance property, at 34 for Lender Services required for equity for property. If a plurality of Services 26-34 are required, then the program provider will collect all information required for each service without redundant entries by consumer, as at 36.

A service provider is directed as in 20 and 24 to provide information, including location information, e.g., a zip code area or a specific location. Service providers would typically provide detailed information including a true identity.

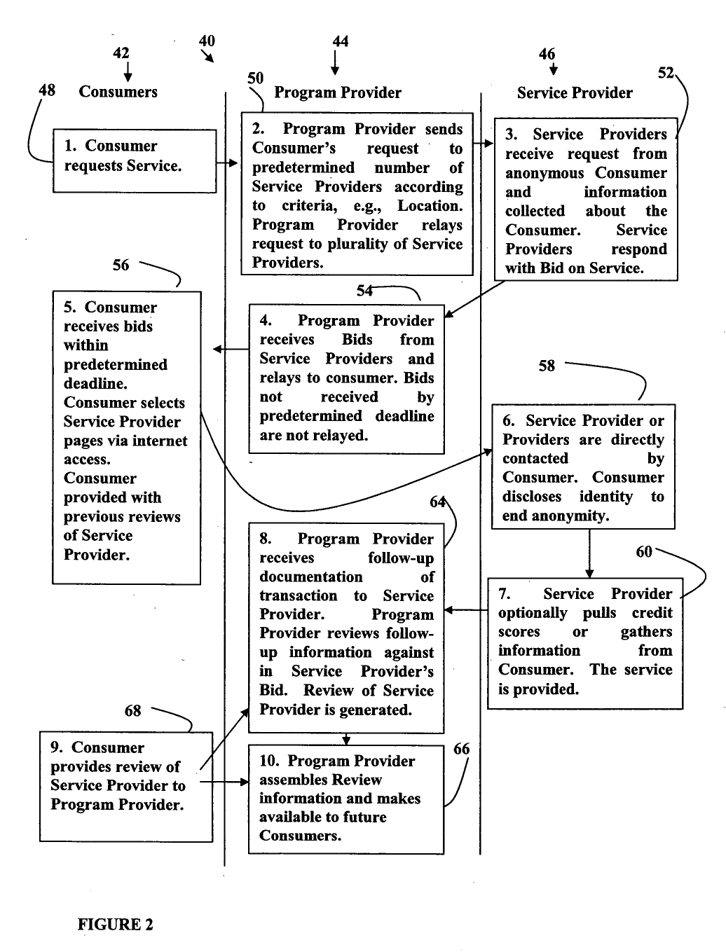

As depicted in FIG. 2, processing steps 40 may be used to direct interactions between consumers 42, the program provider 44, and a service provider 46. In this embodiment, the consumer selects and requests a service at 48, the program provider sends the consumer's request to a predetermined number of service providers according to predetermined criteria, e.g., location of the consumer's service and the service provider's location, and/or the number of service providers that are locally located. The program provider then relays the request to plurality of Service Providers as at 50, the service providers receive the request from the anonymous consumer (who is anonymous relative to the service provider and optionally anonymous relative to the program provider) and the service providers also receive select information previously collected about the Consumer by the program provider. Service providers respond with bids on the service as at 52 that is related to the program provider, which relays the same to the consumer. Bids not received by predetermined deadline are not relayed, as at 54. As depicted at 56, the consumer receives bids within a predetermined deadline. The consumer has access to program/service provider summary pages for the bidding service provider provided by the program provider via internet access, e.g., webpages (for example, a WHY PICK ME page). Consumers are optionally provided with previous reviews of service provider 56. The service provider or providers are then directly contacted by the consumer, who then discloses his identity to end anonymity relative to the service provider, as at 58. Alternatively, the consumer may continue to maintain anonymity by indicating the same to the program provider or contacting the service providers directly. The service provider optionally pulls credit scores or gathers other information from the consumer. Upon mutual agreement, the service is provided by the service provider to the consumer, as at 60. Optionally, the program provider receives follow-up documentation of the service transaction from the consumer or the service provider, as at 64. The program provider reviews the follow-up information against the service provider's bid. A review of Service Provider is generated. The consumer also provides a review of service provider to the program provider, as at 68. The program provider assembles the review information and makes it available to future consumers, as at 66.

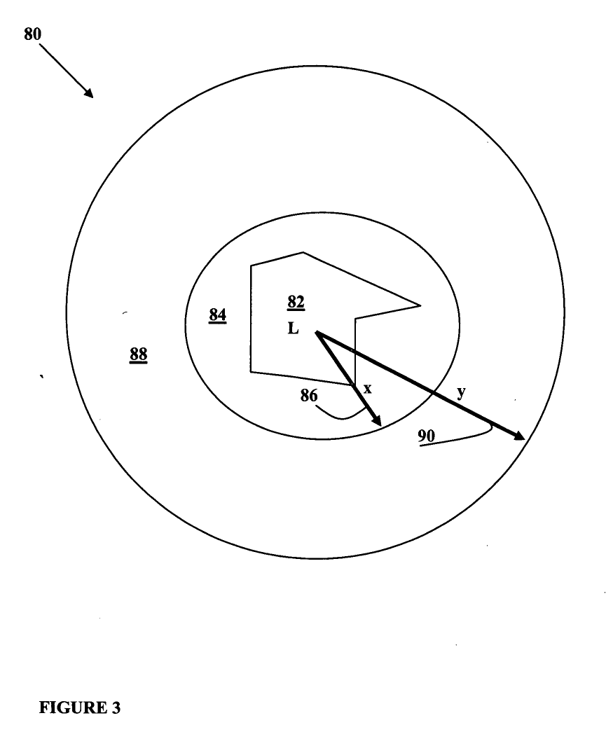

As depicted at FIG. 3, the program provider can use rules 80 to match locations between the consumer and service providers. A consumer's designated location 82 is compared to a database of service provider locations. Service provider locations within area 84 which is within a predetermined distance, x, shown at 86 from location 82 or from a location indicated as L in 82, are compared against location 82. The predetermined number, a, of service providers closest to location 82 are chosen and given an opportunity to bid to provide the service. If the number of service providers within distance x is less than a, then the locations of additional service providers are determined, with the closest providers being added to the list of potential bidders until the predetermined number a is met. All of the service providers, however, may be limited to a distance, y, as at 90, relative to the consumer's designated location. Thus the number of service providers notified of the opportunity to bid may be less than a if the total number of service providers within areas 82, 84, 88 is less than a. The consumer's designated location may be an address or an area, e.g., as indicated by designating a zipcode. The distances 86 or 90 may be determined point-to-point from a designated address to an address of the service provider, area to area as in from a consumer's zipcode to all zipcodes of service providers that are fully or partially within the designated distance or a combination thereof, e.g., address-to-area or area-to-address. A reasonable proximity between consumers and service providers is preferable, so that some examples of ranges for x and y (with y being greater than x) are: less than 5, 10, 15, 20, 25, 50, 75, 100, 200. or 300 miles, and all ranges and values therebetween, e.g., 5-50 miles, less than 80 miles; artisans will immediately appreciate that all the ranges and values within the explicitly stated ranges are contemplated. While lower values may be preferred in urban areas, relatively greater values may be preferred in rural areas, with such considerations optionally being a variable for setting x and/or y. The number a may be set by the consumer or the program provider, for example, between 1-50 and all ranges and values therebetween, e.g., 1-20, 1-10, 1-3, 5-15, 3-20; artisans will immediately appreciate that all the ranges and values within the explicitly stated ranges are contemplated. The program provider indicates to the service provider how many service providers were requested to bid and is later notified how many actually bid; alternatively, one of both of these items is not provided.

In some embodiments, service providers are required to sign up for no more than one area, e.g., as defined by a zipcode area or distance from a specific location. The program provider can provide metrics to assist the service provider in that choice, e.g., the number of service providers in a potential area, and/or the number of past transactions in that area, the number of consumers already registered in that area.

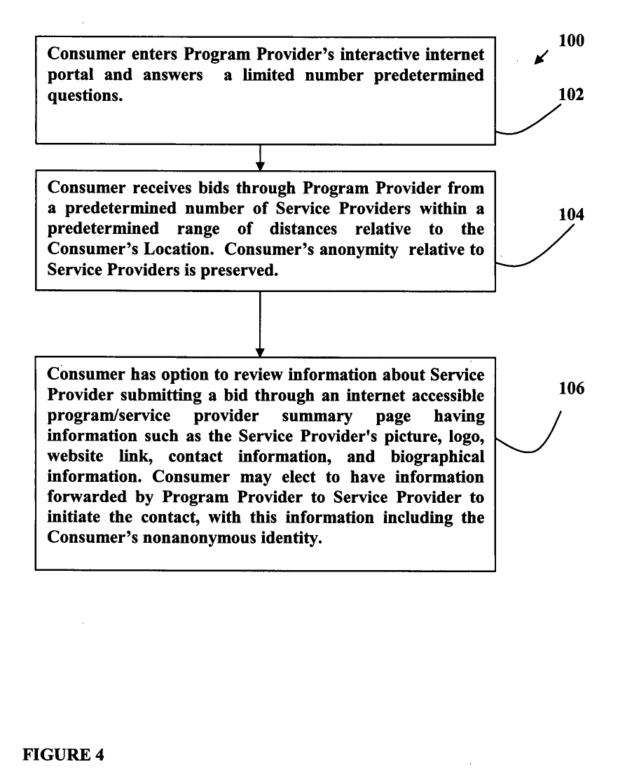

As depicted at FIG. 4, the program provider can provide an interactive web-based system that guides a consumer through a series of steps to effectively match the consumer with a plurality of service providers. The system 100 provides consumer entry through program provider's interactive internet portal and asks the consumer a limited number, c, of predetermined questions at 102. Consumer receives bids through program provider from a predetermined number of service providers within a predetermined range of distances relative to the consumer's location. Consumer's anonymity relative to service providers is preserved at 104. Consumer has the option to review information about a service provider who is submitting a bid by opening an internet accessible page having information such as the service provider's picture, logo, website link, contact information, and biographical information. Consumer may elect to have information provided by the Consumer forwarded by program provider to service provider to initiate the contact, with this information including the Consumer's nonanonymous identity, as at 106. The number of predetermined questions, c, may vary, bearing in mind that a minimum number of questions is desired to make the consumer's experience as efficient as possible, but adequate information to provide a basis for making a bid is needed. Examples of the number of predetermined questions, c, is no more than 50, 25, 20, 15, or 10; artisans will immediately appreciate that all the ranges and values within the explicitly stated ranges are contemplated, e.g., 10-20, 15-25, no more than 27.

The above examples are directed to various embodiments of the invention and contain various components. The components are intended to be mixed and matched as guided by the necessity of making operable embodiments; accordingly, the various steps and processes are generally optional, or may be rearranged.

The system may be implemented over the internet using the world-wide-web and other protocols according to programming principles familiar to artisans in this field. While a web-page based interface is a preferred embodiment, other interfaces may be used. The creation of suitable software and interfaces to implement what is described for these systems is within the skill of the ordinary artisan. Some background with respect to the world wide web, computing, online interfaces, and foundational technology is provided in, e.g., U.S. Pat. Nos. 6,785,671, 6,847,938, 6,920,429, 7,089,202, 7,092,904, which are hereby incorporated by references herein to the extent they do not contradict what is explicitly disclosed. Accordingly, the systems described herein may be adapted as needed to accommodate technology developments. Thus computers and software may be employed as needed, with data and programming for the same utilizing various electronic storage tools familiar to those practicing these arts. In some cases, information is stored in electronic computer-readable media so as to be available for reading by a computer as needed to execute processes described herein. In some embodiments, information is collected by posing questions to the user, with the term question referring broadly to any indicia of requesting information, e.g., a fill-in-the-blank, multiple choice, or text field, and includes collecting data without necessarily using an interrogative grammatical construction.

The software may receive designated location information from a consumer. The designated location, in general, will be the location of the property to be purchased, the property to be sold, or the property for which funds are to be borrowed. The designated location can be directed to a specific location, e.g., a street address, global positioning satellite (GPS) coordinate, or a specific area, e.g., a zip code, township, county, parish, neighborhood, city, development, or area bonded by specified roads.

A consumer's identity refers to indicia in the system that indicate a unique user. In some embodiments, the consumer's identity is essentially their username and password. In other embodiments, additional indicia are collected for the user, including, e.g., true name, address, social security number, or telephone number. A consumer can thus be anonymous relative to the service provider and/or program provider. In some embodiments, the consumer is anonymous relative to the service provider until the consumer chooses to end the anonymity (and thereby be nonanonymous), e.g., after receiving a bid or quote for services. An identify including that includes the true first and last name of the identified person may also be referred to as a complete identity.

Agents may be, e.g., real estate agents, real estate brokers, and other service providers. Examples of Agents are Residential real estate agents specializing in existing residential, new construction, condos/townhouse, foreclosed properties, lots/land or investment properties. Agent Services may thus be, e.g., assistance in buying property or assistance is selling property. Lenders may be, e.g., entities that loan money, sell loans, provide lending services, or broker money. Example of lenders are Mortgage Originators (Wholesale Loan Officers), Retail/Correspondent Mortgage Loan Officers, Banks (large and small), Credit Unions, Subprime Loan Officers, Home Equity/2nd Mortgage Loan Officers and Investment Property Loan Officers. Lending services may thus be, e.g., lending for property purchase, lending for refinancing property, or lending for loans based on property equity. Home owner's insurance services may be, e.g., entities that offer home owner's insurance.

Examples of questions for consumers requiring property purchasing services are: Buying/Location: Zip Code and/or specific address/Property: Property Type, Property Usage, Property Value, Closing Timeframe/Agent: Language Agent Speaks, Is Selling Also/Miscellaneous: First Time Buyer, Is Selling First, Being Relocated, Has a Specific School District, Considering New Construction, Only New Construction, Handicap Accessible, Lake Home, Live on Acreage, Very Responsive and Available Agent, Already Found the Home they Want, Not Working with Another Agent, or Email Matching Properties.

Examples of questions for consumers requiring property selling services are: Selling/Location: Zip Code and/or specific address/Property: Property Type, Property Usage, Property Value, Closing Timeframe/Agent: Requested Service, Language Agent Speaks, Showing Condition (1-10), Location (1-10), Is Buying Also/Miscellaneous: Get Property on Market as soon as possible, Located on a Lake, Located on a Pond, Located on Acreage, Monthly Association Fee, Has Been Remodeled, Could Use “TLC” (Tender Loving Care).

Examples of questions for consumers requiring lending services to purchase a property are: Purchase; and/or Location: Zip Code and/or address; and/or Property: Property Type, Property Usage, Property Value, Borrowing Amount, Down Payment, Max Down Payment; and/or Income: Credit History, Annual Income, Monthly Debt, Employment Status, Ever Declared Bankruptcy, Total Assets; and/or Miscellaneous: 30 Year Mortgage, 15 Year Mortgage, 10 Year Mortgage, Comparing Mortgages, Close Within 40 Days, Fixed Rate, Adjustable Rate, Assist in Finding Best Program, Interest Only Loan, Worked Same Place 2 Years, First Time Buyer, Veteran, Fixed Loan to an Adjustable Loan, Combo Loan, Must Sell before Buying, Must Finance before Selling, Lived in Home 2+ Years out of 5, Learn More on Seller Paid Closing Costs, Lower Closing Costs vs Lower Rate, Lower Rate vs Lower Closing Costs, I want one Jumbo Loan, Prefer 1st & 2nd Mortgage over Jumbo Pricing.

Examples of questions for consumers requiring lending services to refinance a property are: Refinance; and/or Location: Zip Code and/or address; and/or Property: Property Type, Property Usage, Property Value, Borrowing Amount, Refinancing Goal, Currently Owed Amount, Current Interest Rate; and/or Income: Credit History, Annual Income, Monthly Debt, Employment Status, Ever Declared Bankruptcy, Total Assets, Monthly Property Tax, Monthly Home Insurance, Monthly Association Fee; and/or Miscellaneous: 30 Year Mortgage, 15 Year Mortgage, 10 Year Mortgage, Comparing Mortgages, Close Within 40 Days, Fixed Rate, Adjustable Rate, Assist in Finding Best Program, Interest Only Loan, Worked Same Place 2+ Years, Combo Loan, Roll Costs into Loan, Lived Same Place 2+ Years, Lower Closing Costs vs Lower Rate, Lower Rate vs Lower Closing Costs, I want one Jumbo Loan, Prefer 1st & 2nd Mortgage over Jumbo Pricing.

Examples of questions for consumers requiring lending services to arrange an loan based on equity in a property are: Equity ; and/or Location: Zip Code and/or address; and/or Property: Property Type, Property Usage, Property Value, Borrowing Amount, Home Equity Goal, Owed on First Mortgage, Interest Rate on First Mortgage, Owed on Other Mortgages, Interest Rate on Other Mortgages; and/or Income: Credit History, Annual Income, Monthly Debt, Employment Status, Ever Declared Bankruptcy, Total Assets, Monthly Property Tax, Monthly Home Insurance, Monthly Association Fee; and/or Miscellaneous: 30 Year Mortgage, 15 Year Mortgage, 10 Year Mortgage, Comparing Mortgages, Close Within 40 Days, Fixed Rate, Adjustable Rate, Assist in Finding Best Program, Interest Only Loan, Worked Same Place 2 Years, Roll Costs into Loan, Lived Same Place 2+ Years, Want Very Low Closing Costs.

Examples of questions for consumers requiring home owner's insurance are property address, year built, claim history, mortgage amount, and questions related to replacement cost of home (style of home, finished square footage, decks, fireplaces, attached or detached garage, etc.). Insurance agent is then able to bid on yearly home owner's insurance quote and replacement value.

Bids (a term including a quote for services that takes place outside of an auction) can include a variety of information, with the program provider requiring various portions of that information to be provided to the program provider and/or consumer. Information is a term that includes knowledge or data pertaining to an entity (person or object).

Examples of information in a lender's bid is: interest rate, the annual percentage rate (APR), total closing costs at time of closing and cash needed up front (if any) to work with that lender.

In some embodiments, the program provider requires that lenders will bid on a 30 year fixed rate mortgage (or other specified mortgage package) with no prepayment penalty, no teaser rate, with a 30 day lock and amortized over 30 years (or other appropriate specified time) for most bids so as to can easily compare similar products, in other words: comparing apples to apples. (Home equity loans and some subprime products may not offer a 30 year fixed rate, so more questions may be required as appropriate for lenders of certain products). Once a consumer selects a lender, all lenders agree to abide by a guaranteed mortgage pricing formula which offers consumers the same or better pricing formula on day of lock as what was used on day of bid. Whatever program or product the consumer ultimately selects, the guaranteed mortgage pricing formula with adjustments will be utilized by the service provider.

Thus, in some embodiments, a Guaranteed Mortgage Pricing formula is applied. When lenders prepare their initial bid, they basically use a complicated formula to determine the interest rate, closing costs and cash needed up front. Guaranteed Mortgage Pricing prevents lenders from what is known as bait and switch, i.e. offering one rate, but when it comes time to lock, providing a much higher rate. Rates can and do change daily; they will either go up or down. When rates go down, Lenders agree to use the same formula to determine the new rate and closing costs. However, if rates go up, the same is true, and lenders will offer the higher rate and/or closing costs. It is a win-win for both the lender and the consumer. If the lender agrees to provide a mortgage to a consumer for $X amount on the day they bid, they will agree to offer that same $X amount on the day the consumer is ready to lock-in the loan. One embodiment of a Guaranteed Mortgage Pricing formula is:

### Day of Bidding

Total Closing Costs=$A (lender/loan officer will manually enter on day of bid) Yield Spread/Service Release Premium/Any Premiums at interest rate of X%=$B

(loan amount times ysp/srp/premium, etc.) (determined by rate that is quoted) Total Cash needed up front=$C (manually bid on)

A+B+C=D (Total Bid Price on day of bid)

### Day of Lock Total Cash paid up front=$E

YSP/SRP/Premiums (including any adjustments made)=$F (loan amount times ysp/srp/premiums, etc. on day of lock)

D−(E+F)=G (Total Closing Costs).

In some embodiments, the program provider requires that agents assisting a consumer selling property will bid on the: (1) Total cash needed up front to work with that agent (if any); (2) Total commission that would be charged to perform the type of services selected; (3) What part (if any) of the total commission charged above would be paid to the cooperating broker/agent that brings in the buyer for the property; (4) Total other fees, if any, usually paid at time of closing; and/or (5) If agents are buying/building in the same area consumer are selling (roughly a 30 mile radius) what percentage the agent would take off of the total commission noted above if agent was also to be used to sell and buy/build and the agent is also paid a commission when there is a buy/build. This information relates to agents providing discounts in return for representing a consumer in more than one transaction. Another question that an agent may be required to answer is: What charge, if any, for just a CMA on the property (Comparative Market Analysis, which is used to properly price a property). Commission may be, in some embodiments, payable only upon a successful closing.

In some embodiments, the program provider requires that agents assisting a consumer buying and/or building a property will bid on the: (1) Cash needed up front to work with that agent (if any); (2) The estimated percentage of time that the seller pays their commission in their market; (3) The highest percentage fee it may cost if consumer finds a property that the seller does not pay their commission; (4) Total other fees, if any, that may apply, usually at closing; and/or (5) Any incentive(s) the agent would like to offer (cash back, free home warranty, free home inspection, for example). Commission may be, in some embodiments, payable only upon a successful closing.

In some embodiments the service providers are required to return bids in a timely fashion to meet certain deadlines. For example, the program provider may deliver bids to consumers within a predetermined time relative to the consumer's time of request. Examples of the predetermined time are: 24 hours, 48 hours, or 1 week; or before the end of the next business day, or by a set time (e.g., 3, 4, 5, 6, 7, or 8 p.m., or any other hour or time, e.g., 7:22 am), or by a set time that is at least x hours away, with x being, e.g., between 1-72 hours; artisans will immediately appreciate that all the ranges and values within the explicitly stated ranges are contemplated, e.g., 6 hours, or 12.5 hours. For example, the program provider may provide the bids to a consumer by the 7 p.m. if 7 p.m. is more than 6 hours away from the time of submission; otherwise the bid would be provided by 7 p.m. the following day—in this example, consumers submitting a request before 1 p.m. will have bids by 7 p.m. the same day; otherwise they would receive the bids by 7 p.m. the following day. Alternatively if the bid deadline may be 7 p.m. Central Time the next full business day after the request is submitted—thus a request submitted at 2 p.m. on Monday will close at 7 p.m. Central Time on Tuesday.

The program provider may configure the software system to provide various features, some of which are described below. Consumers that sign-up with the program provider may be notified via email (or other means, e.g., cellular telephone) when a request is available to bid on. The program provider may require that service providers manually bid to participate in that request. Once the bid deadline has past, the consumer will receive an email that their bids are available to view and may login to view the bids. A consumer may be able to send their email and contact information to service providers for initial contact and/or, consumers may just call or email service providers directly. Each request may have a designated number assigned to it, so the consumer may reference that number when they contact service providers. The program provider may opt not to require any preapprovals to be generated through its programs, with the preapproval process beginning when a consumer chooses the lender he would like to work with. The lender may verify consumer's information at that time. Lenders may bid assuming that the consumer qualifies for the loan amount they are requesting.

In some embodiments, a consumer has the option to review information about a service provider submitting a bid through via internet accessible page posted by the program provider, with such page being referred to as a program/service provider summary page since the service provider and program provider effectively collaborate to create the page accessible through the program provider. The program/service provider summary page may have information such as the service provider's picture, logo, website link, contact information, and biographical information. Consumers may elect to have information forwarded by program provider to a service provider to initiate the contact, with this information including the consumer's nonanonymous identity. Service providers may be able to view how many times a program/service provider summary page has been viewed, with the anonymous identity information optionally being provided to the service provider.

Consumers are optionally able to access previous reviews of service providers. These reviews may be provided by previous consumers or the service provider. In some embodiments, the program provider provides information about the service provider's consistency between quoting and closing based on prior transactions, with the underlying data being provided by prior consumers and/or the service providers. Such reviews may be provided before and/or after a consumer selects service providers. The program provider may provide each service provider with an initial rating of 5 stars, noting that 1 person has rated the member. Consumers may leave ratings or detailed written feedback regarding the service providers they work with. The rating system is an advantageous win-win since consumers can expect a high level of customer service and service providers may be rewarded when they go that extra mile to provide it.

In some embodiments, consumers are required to contact service providers only through the program provider and the number of contacts may be limited, e.g., to less than 20, 20, 5, 3, or any value between 1 and 50, artisans will immediately appreciate that all the ranges and values within the explicitly stated ranges are contemplated.

Optionally, the program provider sends out an email, or otherwise contacts the consumer, at a fixed time after the consumer makes an initial request. For example, the consumer may be contacted between about 10 and 100 days, e.g. about 40 days from the day the initial request is sent; artisans will immediately appreciate that all the ranges and values within the explicitly stated ranges are contemplated. Such contacts can, for example, seek follow-up information, provide new offers, or request feedback.

Service providers may be required to pull credit scores only after they have provided a bid to consumers and the consumer has contacted them with instructions to proceed.

Real estate side agents often have past clients/customers moving to areas they are not familiar with and/or where they are not properly licensed. In some embodiments, therefore, agents or lenders may use the system to provide referrals to each other or to create fee-sharing arrangements. Thus a first agent could solicit quotes from other agents in a location, with the quotes indicating the referral fee that such an agent will provide the first agent. As part of the process, the software may collect information about the potential referral, such as the property to be purchased, the type of property, or its preferred location and cost. Lender may do the same, although under present law, most or all jurisdictions would be limited to providing reciprocal referral relationship since referral fees for lending are unlawful in most situations. In some embodiments, the agent soliciting the referral fee is nonanonymous but in other embodiments, the first agent could stay anonymous until they contact the other agent

Accordingly, an agent could get a small commission check from helping their past client/customer find an agent in the location they are moving. And that same agent providing the referral can have the opportunity for other agents across the country to send business back to them and to pay a small referral fee. For example, a common commission referral fee might range from about 10% to about 30%. So a first agent can provide information to other agents such as price range and time frame, whether or not the buyers have a house to sell before buying, or if the buyers are coming into town as non-contingent buyers. These other agents can provide bids or quotes. If the quoting agent gets a 2.7% fee on a $400,000 purchase, this would be about $10,800; a 20% referral fee would net about $2,160 for sending the referral. One advantage of this system is that there are no other marketing costs are involved, and the quoting agent benefits from having a certain amount of loyalty from the buyer, since the buyer has a trust relationship with the referring agent.

In some embodiments, Fannie Mae/Freddie Mac or other automated underwriting responses are displayed to lenders to allow the lenders to bid accurately. This information will determine the path that is taken for that particular loan since it will advise the lender/loan officer if the secondary market will most likely purchase the loan, along with any necessary conditions needed to make the loan marketable on the secondary market. One advantage of providing this information is that the lenders will be able to meet tight deadlines for turning around quotes so as to make the overall process more timely and efficient.

Various embodiments have been set forth herein, along with certain features. In general, the features can be mixed-and-matched to make alternative embodiments, with the need to make operable systems providing guidance for the same.

It is claimed:

1. A method for providing real estate services to a consumer comprising:
collecting consumer information from a consumer and service provider information from a plurality of service providers through an internet-based interface and mediating an exchange of at least a portion of the information between the consumers and service providers, with the information being collected by a program provider and electronically stored by the program provider;
with the consumer information being provided by the consumer in response to questions posed by the program provider and comprising a consumer information subset of data that comprises:
at least one service to be provided to the consumer that is a member of the group consisting of buying real estate property, selling real estate property, borrowing from a lender to buy real estate property, borrowing from a lender to build on real estate property, borrowing from a lender to refinance real estate property, and borrowing from a lender to based on equity in real estate property,
a location of the real estate property for the service to be provided to the consumer, and
a credit history self-evaluation;
with the service provider information being provided by the service provider in response to questions posed by the program provider comprising:
at least one service to be provided by the service provider that is a member of the group consisting of buying real estate property, selling real estate property, lending to buy real estate property, lending to build on real estate property, lending to refinance real estate property, and lending based on equity in real estate property,
a location of the service provider, and
a true identity of the service provider;
identifying a predetermined number of service providers having a location within a predetermined distance of the location of the real estate property to generate a list of service providers;
sending the consumer information subset of data from the program provider to service providers on the list of service providers, with the consumer being anonymous relative to the service providers;
sending a quote from each of a plurality of the service providers on the list for the at least one service to be provided to the consumer to the program provider;
conveying the quotes through the program provider to the consumer, with the quotes being provided to the consumer within a predetermined time relative to the time of consumer's initiation of the quoting process; and
providing the quotes to the consumer with simultaneous access to a program/service provider summary page and contact information for the quoting service providers;
wherein the consumer is anonymous relative to the service provider until the consumer chooses to contact the service provider.

2. The method of claim 1, wherein a guaranteed mortgage pricing formula is applied to each quote.

3. The method of claim 1, wherein the predetermined time relative to the time of the consumer's initiation of the quoting process is no more than 48 hours.

4. The method of claim 1, wherein the location of the real estate property for the service to be provided to the consumer is a zip code area.

5. The method of claim 1, wherein the predetermined number of service providers is between 5 and 25, and the service provider location within a predetermined distance of the location of the real estate property is no more than 200 miles.

6. The method of claim 1, wherein the predetermined number of service providers is set to a value A between 3 and 50, and the service provider location within a predetermined distance of the location of the real estate property is no more than a predetermined distance x miles if the number of such service providers matches or exceeds value A, in which case other service providers located within a second predetermined distance y miles will be selected and added to the list until the first of: (a) the number of service providers on the list is equal to value A or (b) the potential service providers within the second predetermined distance is exhausted in which case the list will have fewer service providers than value A.

7. The method of claim 6 wherein A is 20, x is about 20 and y is about 200.

8. A software program to implement the method of claim 1.
